(19) United States
(12) Patent Application Publication
(10) Pub. No.: US 2003/0073450 A1
(43) Pub. Date: Apr. 17, 2003

(54) Method and apparatus for confirmation of receipt of multimedia messages

(76) Inventors: Josef Laumen, Hildesheim (DE); Andreas Schmidt, Braunschweig (DE); Sabine Van Niekerk, Salzgitter (DE); Ralf Prenzel, Salzgitter (DE); Markus Trauberg, Vechelde (DE)

Correspondence Address: Bell, Boyd & Lloyd LLC, P.O. Box 1135, Chicago, IL, 60690, US

(21) Appl. No.: 10/120,995

(22) Filed: Apr. 10, 2002

(30) Foreign Application Priority Data
Apr. 10, 2001 (DE) 101 17 894.8

(51) Int. Cl. H04M 3/42; H04Q 7/20

(52) U.S. Cl. 455/466; 455/414

(57) ABSTRACT

Given that a sender of a multimedia message is generally unclear about the whereabouts of the message if the message has first been stored in a mailbox for the receiver and the receiver has neither been able to be notified about this message in the mailbox nor has downloaded the message, a connection unit associated with the receiver produces a notification which is then sent to a sender connection unit and on to the sender, and the type of notification required by the sender, or other, can be coded in the header of the send request in which the sender sends the multimedia message, wherein the receiver receives individual feedback about the whereabouts of the multimedia message.

### BACKGROUND OF THE INVENTION

The present invention relates to a method for sending a message by sending the message to a receiver connection unit associated with a receiver using a send request. In particular, the present invention relates to the confirmation for the sender of a multimedia message in the multimedia message service (MMS) about the arrival of this multimedia message in the receiver's mail inbox and about the requesting of such a confirmation.

Besides voice telephony, the mobile radio system GSM (Global System for Mobile Communications, see also list of abbreviations) also affords the opportunity to send and receive short text messages of up to 160 characters in length. This service is called short message service (SMS).

For the mobile radio system of the next generation, UMTS (Universal Mobile Telecommunication System), a variant of a mobile message service is currently being standardized which has a multimedia capability and is called the multimedia messaging service (MMS) based on 3G TS 23.140 version 4.2.0, Release 4; Third Generation Partnership Project; Technical Specification Group Terminals; Multimedia Messaging Service (MMS); Functional Description; Stage 2, and 3G TS 22.140 v.4.1.0: 3rd Generation Partnership Project; Technical Specification Group Services and System Aspects; Service Aspects; Stage 1 Multimedia Messaging Service. Messages having multimedia contents are merely called MMs (Multimedia Message) for short below, in order to provide better distinction from the text messages of the SMS. In contrast to the SMS, there is no longer any limitation to pure text content. The MMS will allow texts to be formatted on the basis of individual taste and will allow any desired content to be embedded into a message. This includes, inter alia, audio and video content, still pictures, graphics and text.

On the basis of the prior art to date, the MMS can be implemented using the WAP (Wireless Application Protocol) only. To bridge the air interface between a terminal with MMS capability and the WAP gateway, WAP-209-MMSEncapsulation, Wireless Application Protocol; WAP Multimedia Messaging Service; Message Encapsulation; MMS Proposed SCD 1.0 and WAP-203-WSP, Version 4-May-2000; Wireless Application Protocol, Wireless Session Protocol Specification; Chapter 8.4: “Header Encoding” provide for the use of the WAP wireless session protocol (WSP). FIG. 1 shows a general message flow diagram based on today's prior art, which shows the interchange of the MMS messages between the entities involved (MMS user application A (abbreviated to M-UA A below), MMS connection unit A (M-SR A below), MMS connection unit B (M-SR B below), MMS user application B (M-UA B below)) when an MM is sent and received. MMS user application (M-UA) is understood as an application on a mobile radio or on an appliance connected to a mobile radio (e.g., laptop, or the like) which implements MMS functionality. An MMS connection unit (M-SR) is a network element associated with an MMS service provider (MMS Service Provider) which makes the MMS functionality available to the MMS user applications. A multimedia message fundamentally includes a header part (the “header”) and a data part (the “body”) which contains the multimedia objects.

Between the elements involved, the information is interchanged using messages, which are shown by arrows in the general message flow diagram in FIG. 1 (“M-UA A sends MMA to M-UA B”).

A sender M-UA A sends a multimedia message (MM) with an MMS send request M-Sreq to the sender connection unit or MMS connection unit A, M-SR A. The M-SR A responds to the M-UA A with an MMS send confirmation M-Sconf that the M-Sreq has arrived. The M-SR A forwards the MM to the receiver connection unit M-SR B. The receiver M-UA B of the MM is notified by the M-SR B, using an MMS receiver notification M-Nind, that there is a multimedia message available for the receiver to pick up in the receiver's MMS mail inbox (M-mailbox below) on the M-SR B. The receiver confirms receipt of the M-Nind to the M-SR B using an MMS receiver notification confirmation M-NRind. The receiver now has the opportunity to request the message provided for him/her from the M-SR B at a later time using an MMS delivery request W-Greq. The M-SR B transmits the requested multimedia message with an MMS delivery message M-Rconf to the M-UA B. The latter confirms receipt of the M-Rconf using an MMS delivery confirmation M-Aind. The M-SR B generates from the M-Aind an MMS delivery notification M-Dind which is transmitted to the sender M-UA A via the M-SR A.

The general message flow diagram presented here relates to the case of “later download” of an MM (see WAP-209-MMSEncapsulation). The case of “immediate download” (likewise see WAP-209-MMSEncapsulation) of an MM differs primarily in the sequence of some of the messages. The inventive method also can be applied to this case without any fundamental restrictions. The case of “immediate download” is therefore not mentioned in more detail below.

On the basis of 3G TS 23.140, the M-Aind and the M-Dind are optional in the MMS. In addition, an option provided in the MMS is that the sender can receive an MMS delivery notification M-Dind following the M-NRind if an error has occurred (e.g., the MM has exceeded a prescribed time limit), if the receiver sends back the MM, if the MM is loaded immediately and, optionally, if the MM is not downloaded from the M-SR B until later.

However, the MMS does not have the capability to inform the sender of a multimedia message that the sent MM has arrived in the receiver's M-mailbox.

Accordingly, an object of the present invention is to provide a way of informing the sender of a message, in particular a multimedia message, that the message which he/she has sent has arrived in the receiver's mailbox. In addition, on a general basis, the intention is to provide the opportunity for the sender to request the type of status report. In this context, it is desirable for the sender to be able to specify which notifications he/she wishes to receive.

### SUMMARY OF THE INVENTION

Advantageously, in accordance with a first embodiment, the present invention allows the introduction of a notification under the MMS (Multimedia Messaging Service) which notifies the sender of a multimedia message (MM) in the MMS that the MM which he/she has sent has arrived in the receiver's MMS mail inbox (M-mailbox) on the M-SR B, irrespective of whether the receiver has already been notified about the new MM in the M-mailbox.

Preferably, a second embodiment affords the opportunity for the sender of a multimedia message MM to select the type of transmission confirmation in the MMS.

A third embodiment makes it possible for the receiver to be notified, in the notification about a new MM in the M-mailbox, of whether the sender has received a transmission confirmation about arrival in the M-mailbox.

In addition, a fourth embodiment affords the opportunity for the receiver to prevent the sender from being notified about the arrival of the receiver's multimedia message MM in the receiver's M-mailbox.

A fifth embodiment of the present invention allows the notification introduced in accordance with the first embodiment to be coded.

In addition, a sixth embodiment of the present invention provides for the information introduced in accordance with the second embodiment (the request for a particular type of transmission confirmation) to be coded in the header part of a multimedia message (MM).

In accordance with a seventh embodiment, the corresponding information relating to the third embodiment of the present invention can be coded in the header part of a multimedia message MM.

Additional features and advantages of the present invention are described in, and will be apparent from, the following Detailed Description of the Invention and the Figures.

### BRIEF DESCRIPTION OF THE FIGURES

FIG. 1 shows a general message flow diagram in the multimedia message service (MMS) based on the prior art.

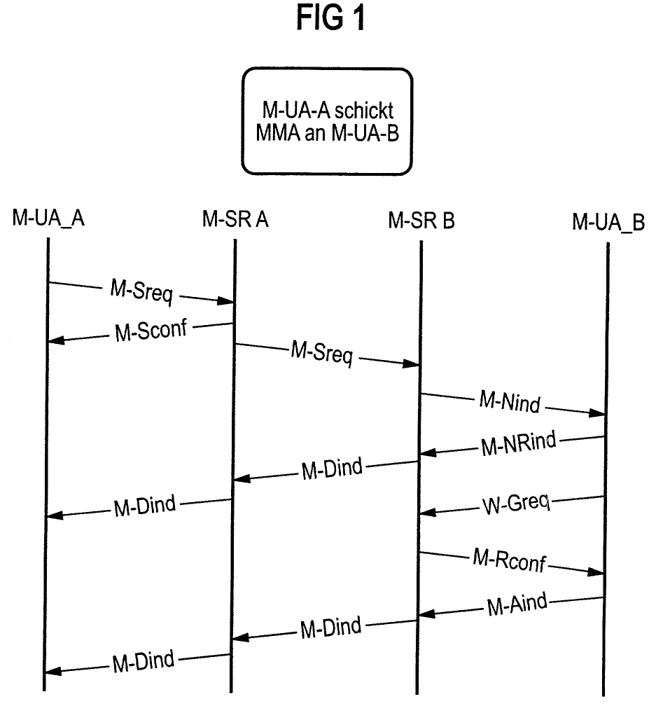

FIG. 2 shows a message flow diagram in accordance with the present invention in the multimedia message service (MMS).

### DETAILED DESCRIPTION OF THE INVENTION

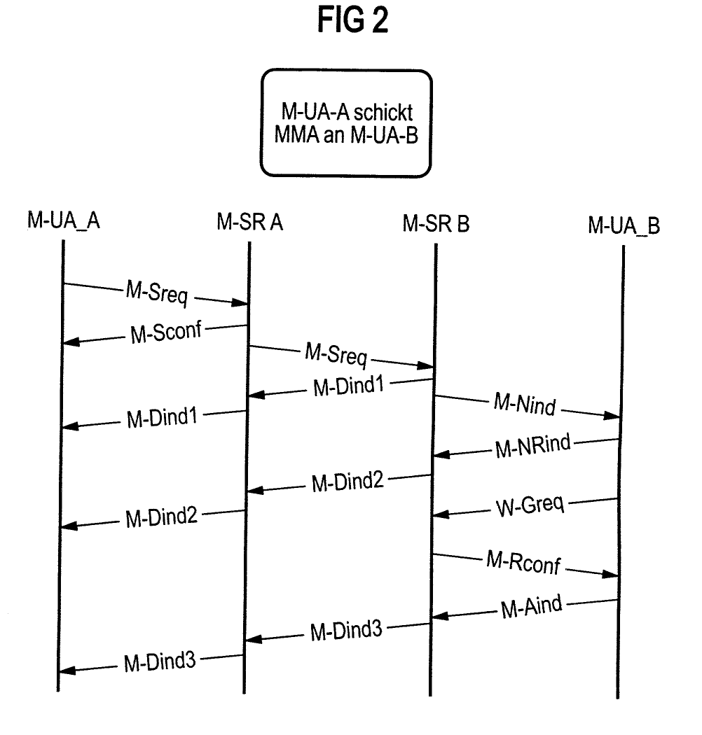

FIG. 2 shows the general message flow diagram in accordance with the present invention. The receiver connection unit M-SR B, having received the send request M-Sreq, sends a delivery notification M-Dind 1 to the sender switching unit M-SRA. This, in turn, forwards the delivery notification M-Dind 1 to the sender M-UA_A.

The first embodiment of the present invention, in which the sender of a multimedia message is basically notified about the arrival of this message in the receiver's mailbox, is found to be advantageous, particularly in the following scenario:

It is assumed that the sender sends an important MM to a receiver and requests transmission confirmation for this MM. However, if the receiver currently cannot be notified about the status of his/her M-mailbox regularly (e.g., if the receiver does not turn on his/her mobile telephone while he/she is on holiday for a number of weeks), then the sender will initially receive no transmission confirmation, on the basis of the prior art. Only when the receiver is notified about new MMs in the M-mailbox again does the sender receive transmission confirmation. This circumstance is extremely inconvenient for the sender. In the meantime, he/she will assume that his/her MM has not arrived due to a transmission error, and will probably resend the MM (unsuccessfully) several times.

By contrast, the present invention allows the sender to be informed that his/her MM has reached the receiver's M-mailbox. This helps the sender to dismiss transmission errors.

The second embodiment of the present invention allows the sender of a multimedia message MM to select the type of transmission confirmation in the MMS; i.e., whether he/she (the sender) wishes to receive confirmation in the following situations:

a) after the MM he/she has sent has arrived in the receiver's M-mailbox,

b) and/or after the arrival of the M-Nind has been confirmed by the receiver,

c) and/or after the receiver has downloaded the MM to the reception unit from the M-SR.

On the basis of the prior art, it has been left up to the receiver's MMS service provider what type of transmission confirmation a sender receives. According to the present invention, the sender is given the power of decision regarding selection of the type of transmission confirmation desired, and he/she has the ability to select one or more types.

The third embodiment of the present invention provides for the notification about a new MM in the M-mailbox to be used to notify the receiver about whether the sender has received transmission confirmation regarding arrival in the M-mailbox.

In this context, however, it is advantageous if the sender of a multimedia message (MM) in the MMS is also given the opportunity to suppress the aforementioned indication/notification to the receiver; namely, that he/she (the sender) has received notification after his/her message has arrived in the receiver's M-mailbox.

The fourth embodiment of the present invention provides for the receiver to be able to prevent the sender from being notified about the arrival of the receiver's multimedia message MM in the receiver's M-mailbox. This option can be coded in the settings in the receiver's MMS user profile on the MMS connection unit, and can be dynamically adjusted; e.g., using WAP-UAProf, Wireless Application Group, User Agent Profile Specification.

The fifth embodiment of the present invention provides for the notification to be coded. This notification for the situation in which the multimedia message (MM) sent by the sender has arrived in the receiver's M-mailbox is based on the M-Dind provided in 3G TS 23.140, WAP-209-MMSEncapsulation and WAP-203-WSP and can, in principle, be coded in the header part of the M-Dind as follows:

The M-Dind is used as shown in illustration 2 (denoted there by M-Dind1), and in the header part (header) of the M-Dind the possible values of an existing data element (header field) are extended in order to indicate the status of the sent MM (as shown in table 1).

The sixth embodiment of the present invention makes it possible to code the request for a particular type of transmission confirmation.

The information regarding what confirmation(s) the sender wishes to receive can be coded in a number of ways:

1) In the header part of the M-Sreq (see table 2) or of the M-Rconf, the possible values of an existing data element (header field) are extended in order to request the appropriate notifications. The existing data element (X-Mms-Delivery-Report) has, up to now, the possible values (Yes|No) (see WAP-209-MMSEncapsulation) and is extended by the values shown in table 3. An association between the newly defined values and the corresponding cases a) to c) of the second embodiment is given in table 4.

In addition, the header part of the M-Nind (see table 5) has a data element (X-Mms-Delivery-Report) as shown in table 3 added to it which indicates to the receiver that the sender of the MM wishes to have an M-Dind relating to the reception of the M-Nind. In the new data element (X-Mms-Delivery-Report), the values shown in table 3 are used. This information in M-Nind is based on an implementation of the first part of the embodiment 3.

2) Variant only for case a) of the second embodiment: the header part of the M-Sreq (see table 2) has a data element (X-Mms-Inbox-reached-Report) as shown in table 6 added to it which indicates to the reception-end M-SR B that the sender of the MM wishes to receive an M-Dind relating to the arrival of the MM in the receiver's M-mailbox.

3) Variant only for case b) of the second embodiment: the header part of the M-Sreq (see table 2) has a data element (X-Mms-Notification-Report) as shown in table 7 added to it which indicates to the receiver that the sender wishes to receive an M-Dind after the M-Nind for the corresponding MM has arrived with the receiver.

4) Combination including variant 2) and variant 3) in order to cover cases a) and b) together.

5) Combination including variant 2) and variant 3) with only one new data element (as shown in table 7 or table 6) and corresponding values from variant 1) in order to cover cases a) and b) together.

Of the five possibilities, the first has the advantage that, for the M-Sreq from M-UA A to the M-SR A, or for the M-Rconf from the M-SR B to the M-UA B, it is not necessary to transmit a new data element, but rather an existing data element is just extended by a few values. An additional advantage is that this extension is within the scope of the data size provided on the basis of the prior art. In comparison with variants 2) to 5), no additional data volume is transmitted.

Of the variants described here, the variant 1) should be implemented by way of preference.

Finally, in accordance with the seventh embodiment of the present invention, the subsection in the third embodiment can be implemented. That is to say, the sender specifies in the M-Sreq not just the type of transmission confirmation about arrival in the M-mailbox he (the sender) wishes to receive, but also whether the receiver is to be notified that such confirmation is being sent. This information can be coded in the header part of a multimedia message MM.

In a similar manner to variant 1 of the fourth embodiment, the coding as shown in table 8 is proposed. An association between the newly defined values and the corresponding cases a) to c) of the second embodiment is given in table 9, which correspond to the serial numbers 2 to 7 (as in table 4). The values in the serial numbers 9 to 12 allow the sender to select the type of transmission confirmation and at the same time to prevent the receiver from being informed.

Exemplary Embodiment

The exemplary embodiment below demonstrates the option for the sender to receive all confirmations for cases a)-c) of the second embodiment as per variant 1 of the fourth embodiment.

The following scenario is assumed by way of example: a sender M-UA A (User A) sends a multimedia message MM_{A}, including a text, to a receiver M-UA B (User B). The messages below are transmitted between the units. For this MM_{A}, the sender wishes to receive all types of transmission confirmation.

MM_{A} is sent to the addressee.

M-Sreq (MMS User Agent A→MMS Relay A):

X-Mms-Message-Type: m-send-req

X-Mms-Transaction-ID: TRANSACTION-ID#1

X-Mms-Version: 1.0

Date: Fri, 14 Jul 2000 14:12:19+0100

From: usera@siemens.de

To: userb@siemens.de

Subject: Photo of laboratory setup

X-Mms-Priority: High

X-Mms-Delivery-Report: All

Content-Type: text/plain;

nEntries: 1

HeadersLen: XX

DataLen: XX

Hello User B,

Please send me the picture of our laboratory setup quite urgently.

Regards

User A

In the M-Sreq, the extended data element for requesting all notifications is coded in the header part (recorded in gray).

The M-Sreq from the M-UA A is acknowledged by the M-SR A using an M-Sconf. Within the scope of the present invention, this message is not modified and is, therefore, not shown here.

The M-Sreq is transmitted essentially unchanged between the M-SR A and the M-SR B in line with 3G TS 23.140. This and all other messages between the M-SRs are, therefore, not shown further.

The MMS has provision for the reception-end M-SR to store the MM; that is to say, to store it in the receiver's M-mailbox. On the basis of the present invention (case a), an M-Dindl is now generated by the reception-end M-SR B, which notifies the sender that his/her MM has arrived in the receiver's M-mailbox. The M-Dind1 is not sent if the receiver prevents this by using appropriate settings. The M-Dind1 transmitted from the M-SR A to the M-UA A has the following appearance:

M-Dind1 (M-SR A→M-UA A)

X-Mms-Message-Type: m-delivery-ind

X-Mms-Version: 1.0

X-ns-Message-ID: MESSAGE-ID#1

Date: Fri, 14 Jul 2000 14:14:29+0100

To: userb@siemens.de

X-Mms-Status: Inbox-reached

In this example, the new message contains the status “Inbox-reached”, which notifies the sender User A that his/her MMA has arrived in the M-mailbox of the receiver User B (see table 3).

The MMS based on 3G TS 23.140 and WAP-209-MMSEncapsulation has provision for a receiver of an MM to be informed about new messages which are available for him/her. The M-Nind is used to notify the addressee about MMs which are available for download. In this example, a notification is sent to the receiver User B.

M-Nind (M-RS B→M-UA B):

X-Mms-Message-Type: m-notification-ind

X-Mms-Transaction-ID: TRANSACTION-ID#2

X-Mms-Version: 1.0

From: usera@siemens.de

X-Mms-Message-Class: Personal

X-Mms-Message-Size: XXX (Attachments+Header)

X-Mms-Expiry: 3600

X-Mms-Content-Location: www.sal.siemens.de/mms-inbox/ABCD. 1234

Subject: Photo of laboratory setup

X-Mms-Delivery-Report: All

On the basis of the present invention, the M-Nind has a new data element added to it (X-Mms-Delivery-Report, see table 3) which notifies the receiver (M-UA B) of which notifications the sender wants regarding his/her MM.

The M-Nind is answered with an M-NRind. This response has provision for the receiver to be able to prevent any notification to the sender. Within the scope of the present invention, this message is not altered. As such, it is not shown further in this example.

If the receiver permits notification to the sender, an M-Dind2 is generated by the M-SR B and is sent to the M-UA A. The status value “Deferred” can be used in this case.

M-Dind2 (M-RS A→M-UA A):

X-Mms-Message-Type: m-delivery-ind

X-Mms-Version: 1.0

X-Mms-Message-ID : MESSAGE-ID#1

Date: Fri, 14 Jul 2000 16:10:10+0100

To: userb@siemens.de

X-Mms-Status: Deferred

Downloading of the MM_{A} is prompted by the W-Greq. The MM is then sent to the receiver M-UA B by the M-SR B with an M-Rconf.

M-Rconf (M-RS→M-UA B):

X-Mms-Message-Type: m-retrieve-conf

X-Mms-Transaction-ID: TRANSACTION-ID#3

X-Mms-Version: 1.0

Date: Fri, 14 Jul 2000 16:52:19+0100

From: usera@siemens.de

To: userb@siemens.de

X-Mms-Message-ID: MESSAGE-ID#1

Subject: Photo of laboratory setup

X-Mms-Priority: High

X-Mms-Delivery-Report: All

Content-Type: text/plain;

nEntries: 1

HeadersLen: XX

DataLen: XX

Hello User B,

Please send me the picture of our laboratory setup quite urgently.

Regards

User A

The M-Rconf contains the data element X-Mms-Delivery-Report with the values extended in accordance with the present invention (table 3 and table 10). The M-UA B is thus notified of which notifications the sender (M-UA-A) wants regarding his/her MM.

The rest of the messages in an MMS implementation are unaffected by the present invention and are not illustrated here.

By way of addition, reference is made here to table 11, which shows the allocation of binary codes to the field names; in particular to the field names used in accordance with the present invention.

Moreover, while the present invention has been described with reference to specific embodiments, those of skill in the art will recognize that changes may be made thereto without departing from the spirit and scope of the present invention as set forth in the hereafter appended claims.

TABLE 1
Tables

X-Mms-Status (0x14):

Status-value = Expired |

Retrieved |
Rejected |
Deferred |
Unrecognized |
Inbox-reached

Expired = <Octet 128>
Retrieved = <Octet 129>
Rejected = <Octet 130>
Deferred = <Octet 131>
Unrecognized = <Octet 132>
Inbox-reached = <Octet 133>

Coding of the data element and of its parameters (header field) X-Mms-
Status (recorded in gray: specifically based on the fifth embodiment)

| Name | Content | Comment |
|---|---|---|
| X-Mms-Message- | Message-type- | Obligatory. |
| Type | value = m-send- | Specifies the transaction type. |
| | req | |
| X-Mms-Transaction- | Transaction-id- | Obligatory. |
| ID | value | A unique identifier for the transaction. |
| | | This transaction ID identifies only the M- |
| | | Sreq and the corresponding response (M- |
| | | Sconf). |
| X-Mms-MMS- | MMS-version- | Obligatory. |
| Version | value | The MMS version number. In this |
| | | description, the version is 1.0. |
| Date | Date-value | Optional. |
| | | Time at which the message arrives at the |
| | | M-RS A. The M-RS A will produce this |
| | | field if it is not provided by the M-UA A. |
| From | From-value | Obligatory. |
| | | Address of the message sender. This field |
| | | MUST appear in a message sent to a |
| | | receiver. The field CAN be produced by |
| | | the sending M-UA A or CAN be added at |
| | | the M-RS A. |
| To | To-value | Optional. |
| | | Address of the receiver. |
| | | Any number of address fields possible. |
| Cc | Cc-value | Optional. |
| | | Address of the receiver. |
| | | Any number of address fields possible. |
| Bcc | Bcc-value | Optional. |
| | | Address of the receiver. |
| | | Any number of address fields possible. |
| Subject | Subject-value | Optional. |
| | | Subject of the message. |
| X-Mms-Message- | Message-class- | Optional. |
| Class | value | Class of the message. The value “Auto” |
| | | denotes a message which is produced |
| | | automatically by the M-UA B. If the |
| | | message class is “Auto”, the M-UA A |
| | | DOES NOT NEED to request a delivery |
| | | report or read report. |
| | | If the field does not appear, the receiver |
| | | interprets the message as “personal”. |
| X-Mms-Expiry | Expiry-value | Optional, preset: maximum. |
| | | Period of time for which the message will |
| | | be stored on the server, or time until the |
| | | message is deleted. The field has two |
| | | formats, either “absolute” or “interval”. |
| X-Mms-Delivery- | Delivery-time- | Optional: preset: “immediately”. |
| Time | value | Time at which delivery is required. |
| | | Identifies the earliest possible delivery of |
| | | the message to the receiver. The field has |
| | | two formats, either “absolute”or |
| | | “interval”. |
| X-Mms-Priority | Priority-value | Optional. Preset: “normal”. |
| | | Priority of the message. |
| X-Mms-Delivery- | Delivery-report- | Optional. |
| Report | value | Preset is determined when a service is |
| | | ordered. Specifies whether the user wants |
| | | a delivery report (transmission |
| | | confirmation) from each receiver. If the |
| | | message class is “Auto”, the field MUST |
| | | always appear and the value MUST be |
| | | “NO”. |
| | | For the sixth embodiment, variant 1, the |
| | | values of this field are altered by this |
| | | invention in line with table 3. |
| X-Mms-Read-Reply | Read-reply-value | Optional. Preset: “No”. |
| | | Specifies whether the user wants a read |
| | | report from each receiver as a new |
| | | message. |
| X-Mms-Content-type | Content-type-value | Optional. |
| | | Specifies the content type of the MM |
| | | element. |
| X-Mms-Notification- | Delivery-Report- | Optional. |
| Report | Value | Indicates that the sender wants a delivery |
| | | report after the receiver has been notified. |
| | | - cf. also table 7 |
| X-Mms-Inbox- | Delivery-Report- | Optional. |
| reached-Report | Value | Indicates that the sender wants a delivery |
| | | report after the message has been stored in |
| | | the mailbox of the M-RS B. |
| | | - cf. also table 6 |

TABLE 2
Data elements in the header part (header field) of the message
M-Sreq (gray background: specifically based on the sixth
embodiment, variants 2 and 3);

X-Mms-Delivery-Report (0x06):

Delivery-Report-Value = = Yes |

No |
All (Inbox-notified-and
Retrieved) |
Inbox-reached |
Notified |
Inbox-and-notified |
Inbox-and-retrieved |
Notified-and-retrieved

Yes = <Octet 128>
No = <Octet 129>

All (Inbox-notified-and-retrieved) = <Octet 130>
Inbox-reached = <Octet 131>
Notified = <Octet 132>
Inbox-and-notified = <Octet 133>
Inbox-and-retrieved = <Octet 134>
Notified-and-retrieved = <Octet 135>

TABLE 3
Extended coding of the data element (header field) X-Mms-Delivery-
Report and of its parameter values (recorded in gray: specifically based
on the sixth embodiment, variant 1)

| | Delivery report | Delivery report | Delivery report | |
|---|---|---|---|---|
| | following M-Sreq | following M-Nind | following M-Aind | Values (Value) of |
| | (corresponds to | (corresponds to | (corresponds to | the data element |
| Serial | second | second | second | X-Mms-delivery- |
| number | embodiment a) | embodiment b) | embodiment c) | Report |
| 1 | — | — | — | No |
| 2 | X | — | — | Inbox-reached |
| 3 | X | X | — | Inbox-and- |
| | | | | notified |
| 4 | X | — | X | Inbox-and- |
| | | | | retrieved |
| 5 | X | X | X | All (inbox- |
| | | | | notified-and- |
| | | | | retrieved) |
| 6 | — | X | — | Notified |
| 7 | — | X | X | Notified-and- |
| | | | | retrieved |
| 8 | — | — | X | Yes |

TABLE 4
Summary of the possible values of the X-Mms-Delivery-Report field on
the basis of the desired notifications (recorded in gray: specifically
based on the sixth embodiment)

| Name | Content | Comment |
|---|---|---|
| X-Mms-Message-Type | m-notification-ind | Obligatory. |
| | | Specifies the transaction type. |
| X-Mms-Transaction- | A unique | Obligatory. Identifies the notification and |
| ID | identifier | the subsequent transaction which is |
| | | concluded by the next M-NRind. |
| X-Mms-MMS-Version | Version number | Obligatory. |
| | | The MMS version number. In this |
| | | description, the version is 1.0. |
| From | Sender address | Optional. |
| | | If concealment of the sender's address |
| | | from the receiver is supported, the M-RS B |
| | | will not add this field to the message |
| | | header. |
| Subject | Subject-Value | Optional. |
| | | Subject of the message. |
| X-Mms-Message-class | Message-Class- | Obligatory. |
| | Value | Class of the message. |
| X-Mms-Message-Size | Size of message | Obligatory. |
| | | Total size of the message in bytes (octets). |
| X-Mms-Expiry | Expiry-value | Obligatory. |
| | | Period of time for which the message will |
| | | be available. The field has only one |
| | | format: “Interval”. |
| X-Mms-Delivery- | Delivery-report- | Optional. Preset: “No”. |
| Report | value | Indicates whether the user wants a delivery |
| | | report from this receiver. |
| X-Mms-Content- | Content-Location- | Obligatory. |
| Location | Value | This field defines the location at which the |
| | | message is stored. |
| X-Mms-Read-Reply | Read-reply-value | Optional. Preset: “No”. |
| | | Indicates whether the user wants a read |
| | | report from this receiver as a new message. |
| X-Mms-Notification- | Delivery-Report- | Optional. |
| Report | Value | Indicates whether the sender wants a |
| | | delivery report after the receiver has been |
| | | notified in line with embodiment 6, variant |
| | | 3. |
| X-Mms-Inbox- | Delivery-Report- | Optional. |
| reached-Report | Value | Indicates whether the sender wants a |
| | | delivery report after the message has been |
| | | stored in the mailbox on the MMS server |
| | | in line with embodiment 6, variant 2. |

TABLE 5
Data elements in the header part (Header field) of the message
M-Nind (gray background: specifically based on the sixth
embodiment, variants 1 to 3);

X-Mms-Inbox-reach ed-Report (0x90):

Inbox-reached-Report-Value = Yes | No

Yes = <Octet 128>
No = <Octet 129>

TABLE 6
Coding of the new data element X-Mms-Inbox-reached-Report and
of its parameters (based on sixth embodiment, variant 2)

X-Mms-Notification-Report (0x89):

Notification-Report-Value = Yes | No

Yes = <Octet 128>
No = <Octet 129>

TABLE 7
Coding of the new data element X-Mms-Notification-Report and
of its parameters (based on sixth embodiment, variant 3)

X-Mms-Delivery-Report (0x06):

Delivery-Report-Value = Yes |

No |
All |
Inbox-reached |

Notified |
Inbox-and-notified |
Inbox-and-retrieved |
Notified-and-retrieved

|

Inbox-reached-but-not-shown

|

Inbox-and-notified-but-inbox-

not-shown |

Inbox-and-retrieved-but-

inbox-not-shown |

All-but-inbox-not-shown

Yes = <Octet 128>
No = <Octet 129>
All = <Octet 130>
Inbox-reached = <Octet 131>
Notified = <Octet 132>
Inbox-and-notified = <Octet 133>
Inbox-and-retrieved = <Octet 134>
Notified-and-retrieved = <Octet 135>

Inbox-reached-but-not-shown = <Octet 136>
Inbox-and-notified-but-inbox-not-shown = <Octet 137>
Inbox-and-retrieved-but-inbox-not-shown = <Octet
138>
All-but-inbox-not-shown = <Octet 139>

TABLE 8
Extended coding of the data element X-Mms-Delivery-Report and of its
parameters (recorded in gray: based on sixth embodiment, variant 1,
including values based on the seventh embodiment)

| | | | | The request | |
|---|---|---|---|---|---|
| | | | | for a delivery- | |
| | Delivery | | | report after the | |
| | report after | | | MM has | |
| | the MM has | Delivery | Delivery | arrived in the | |
| | arrived in the | report | report | M-mailbox is | Value of the |
| Serial | receiver's M- | following M- | following M- | not indicated | field X-Mms- |
| number | mailbox | Nind | Aind | to the receiver | Delivery-Report |
| 1 | — | — | — | — | No |
| 2 | X | — | — | — | Inbox-reached |
| 3 | X | X | — | — | Inbox-and- |
| | | | | | notified |
| 4 | X | — | X | — | Inbox-and- |
| | | | | | retrieved |
| 5 | X | X | X | — | All |
| 6 | — | X | — | — | Notified |
| 7 | — | X | X | — | Notified-and- |
| | | | | | retrieved |
| 8 | — | — | X | — | Yes |
| 9 | X | — | — | X | Inbox-reached- |
| | | | | | but-not-shown |
| 10 | X | X | — | X | Inbox-and- |
| | | | | | notified-but- |
| | | | | | inbox-not- |
| | | | | | shown |
| 11 | X | — | X | X | Inbox-and- |
| | | | | | retrieved-but- |
| | | | | | inbox-not- |
| | | | | | shown |
| 12 | X | X | X | X | All-but-inbox- |
| | | | | | not-shown |

TABLE 9
Summary of the possible values of the X-Mms-Delivery-Report field on
the basis of the desired notifications, including values based on the
seventh embodiment (recorded in gray)

| Name | Content | Comment |
|---|---|---|
| X-Mms-Message-Type | Message-type- | Obligatory. |
| | value = m- | Specifies the message type. |
| | retrieve-conf | |
| X-Mms-Transaction- | Transaction-id- | Optional. |
| ID | value | Indicates the transaction which has been |
| | | started by M-Nind without M-NRind, or a |
| | | new transaction if delayed delivery was |
| | | wanted. The new transaction ID is |
| | | optional. |
| X-Mms-MMS-Version | MMS-version- | Obligatory. |
| | value | The MMS version number. In this |
| | | description, the version is 1.0. |
| Message-ID | Message-ID-value | Optional. |
| | | This is a unique reference allocated to the |
| | | message (MM_{A}). This ID MUST always |
| | | appear when the sender M-UA A wants a |
| | | read response. |
| | | The ID allows an M-UA A to match the |
| | | read reports to messages sent earlier. |
| Date | Date-value | Obligatory. |
| | | Date and time of sending. |
| From | From-value | Optional. |
| | | Address of the sender. If concealment of |
| | | the sender's address from the receiver is |
| | | supported, the M-RS B will not add this |
| | | field to the message header. |
| To | To-value | Optional. |
| | | Address of the receiver. |
| | | Any number of address fields possible. |
| Cc | Cc-value | Optional. |
| | | Address of the receiver. |
| | | Any number of address fields possible. |
| Subject | Subject-value | Optional. |
| | | Subject of the message. |
| X-Mms-Message- | Message-class- | Optional. |
| Class | value | Message class. If the field does not |
| | | appear, the receiver interprets the message |
| | | as “personal”. |
| X-Mms-Priority | Priority-value | Optional. Preset: normal. |
| | | Priority of the message. |
| X-Mms-Delivery- | Delivery-report- | Optional. Preset: No. |
| Report | value | Indicates whether the user wants a delivery |
| | | report from each receiver. |
| X-Mms-Read-Reply | Read-reply-value | Optional. Preset: No. |
| | | Indicates whether the user wants a read |
| | | report from each receiver as a new |
| | | message. |
| Content-Type | Content-type- | Obligatory. |
| | value | The content type of the message. |
| X-Mms-Notification- | Delivery-Report- | Optional. |
| Report | Value | Indicates that the sender wants a delivery |
| | | report after the receiver has been notified |
| | | in line with embodiment 6, variant 3. |
| X-Mms-Inbox- | Delivery-Report- | Optional. |
| reached-Report | Value | Indicates that the sender wants a delivery |
| | | report after the message has been stored in |
| | | the mailbox on the MMS server in line |
| | | with embodiment 6, variant 2. |

TABLE 10
Data elements in the header part (header field) of the message
M-Rconf; (gray background: specifically based on the sixth
embodiment, variants 2 and 3);

| | Allocated | Serial | |
|---|---|---|---|
| Name | number | number | Comment |
| Bcc | 0x01 | 1 | |
| Cc | 0x02 | 2 | |
| X-Mms-Content-Loca- | 0x03 | 3 | |
| tion | | | |
| Content-Type | 0x04 | 4 | |
| Date | 0x05 | 5 | |
| X-Mms-Delivery-Report | 0x06 | 6 | The values of this field |
| | | | are altered in accordance |
| | | | with table 3 on the basis |
| | | | of this invention (sixth |
| | | | embodiment, variant 1) |
| X-Mms-Delivery-Time | 0x07 | 7 | |
| X-Mms-Expiry | 0x08 | 8 | |
| From | 0x09 | 9 | |
| X-Mms-Message-Class | 0x0A | 10 | |
| Message-ID | 0x0B | 11 | |
| X-Mms-Message-Type | 0x0C | 12 | |
| X-Mms-MMS-Version | 0x0D | 13 | |
| X-Mms-Message-Size | 0x0E | 14 | |
| X-Mms-Priority | 0x0F | 15 | |
| X-Mms-Read-Reply | 0x10 | 16 | |
| X-Mms-Report-Allowed | 0x11 | 17 | |
| X-Mms-Response-Status | 0x12 | 18 | |
| X-Mms-Sender-Visibility | 0x13 | 19 | |
| X-Mms-Status | 0x14 | 20 | |
| Subject | 0x15 | 21 | |
| To | 0x16 | 22 | |
| X-Mms-Transaction-Id | 0x17 | 23 | |
| . . . | . . . | . . . | |
| X-Mms-Notification- | 0x89 | 36 | Alteration in accordance |
| Report | | | with this invention cf. |
| | | | also table 7 (sixth |
| | | | embodiment, variant 2) |
| X-Mms-Inbox-reached- | 0x90 | 37 | Alteration by this |
| Report | | | notification of invention |
| | | | - cf. also illustration 6 |
| | | | (sixth embodiment, |
| | | | variant 3) |

TABLE 11
Allocation of binary codes to the field names, (recorded in gray:
specifically based on the present invention);

1. A method for sending a message, the method comprising the steps of:
sending the message to a receiver connection unit associated with a receiver using a send request; and
enabling optional notification of the sender about a status of the sent message in accordance with a notification mode, using a first notification, after the send request has arrived in the receiver connection unit.

2. A method for sending a message as claimed in claim 1, the method further comprising the step of depositing the message in a mailbox for the receiver in the receiver connection unit, and making the deposited message available for the receiver.

3. A method for sending a message as claimed in claim 1, the method further comprising the steps of:
sending the first notification by the receiver connection unit to a sender connection unit associated with the sender; and
making the first notification received by the sender connection unit available to the sender.

4. A method for sending a message as claimed in claim 1, wherein the message is a multimedia message for a standardized multimedia messaging service.

5. A method for sending a message as claimed in claim 3, the method further comprising the step of stipulating, via the notification mode, sending of at least one of the first notification, a second notification from the receiver connection unit to the sender connection unit if the arrival of a receiver notification-about availability of the message is confirmed by the receiver, and a third notification from the receiver connection unit to the sender connection unit if the receiver has downloaded the message from the receiver connection unit.

6. A method for sending a message as claimed in claim 1, the method further comprising the step of coding the notification mode in a data element in a header part of the send request by the sender.

7. A method for sending a message as claimed in claim 2, the method further comprising the steps of:
generating the first notification by the receiver connection unit; and
coding information about arrival of the send request in the mailbox for the receiver on the connection unit in a data element in a header part of the first notification.

8. A method for sending a message as claimed in claim 1, the method further comprising the step of informing the receiver, by a notification information item, that the sender wants the first notification.

9. A method for sending a message as claimed in claim 8, the method further comprising the step of coding a notification information item in a data element in a header part of a receiver notification.

10. A method for sending a message as claimed in claim 8, the method further comprising the step of coding the notification information item in a data element in a header part of a delivery message which is sent to the receiver by the receiver connection unit when the message is downloaded.

11. A method for sending a message as claimed in claim 2, the method further comprising the step of assigning a status data element in a header part of the first notification a value “Inbox-received” when the message has reached the mailbox for the receiver, which notifies the sender that the message has reached the mailbox for the receiver.

12. A method for sending a message as claimed in claim 5, the method further comprising the step of coding a delivery report data element in at least one of a header part of the send request, the receiver notification and a delivery message with at least one of “Inbox-reached” when the sender requests the first notification, “Notified” when the sender requests the second notification and “Inbox-and-retrieved” when the sender requests the third notification, for purposes of at least one of controlling the receiver connection unit and notifying the receiver about the notification mode in force for the sender.

13. A method for sending a message as claimed in claim 12, the method further comprising the step of coding a notification report data element in a header part of the send request with a field name of the notification report data element as 0×89, and a field value of the notification report data element with YES when the sender wants a notification after a receiver notification has arrived with the receiver, otherwise with NO.

14. A method for sending a message as claimed in claim 13, the method further comprising the step of coding an inbox reached report data element in the header part of the send request with a field name of the inbox reached report data element as 0×90, and field values of the inbox reached report data element with YES when the sender needs to receive the first notification about the arrival of the message in the mailbox for the receiver, otherwise with NO.

15. A method for sending a message as claimed in claim 14, the method further comprising the step of combining the notification report data element and the inbox reached report data element to form one data element for subsequent coding.

16. A method for sending a message as claimed in claim 8, the method further comprising the step of restricting recognizability of the notification mode of the sender with the receiver.

17. A method for sending a message as claimed in claim 2, the method further comprising the step of coding a delivery report data element in a header part of a receiver notification which informs the receiver about the availability of the message.

18. A method for sending a message as claimed in claim 1, the method further comprising the step of preventing the first notification from being sent via the receiver.

19. A method for sending a message as claimed in claim 18, the method further comprising the step of coding the prevention as an option in a multi-media messaging service user profile.

20. An apparatus for sending a message, comprising:
a sender device for sending the message to one of a sender connection unit and a receiver connection unit associated with a receiver using a send request; and
a receiver device for receiving a first notification about a status of the sent message;
wherein the sender device transmits a notification mode to the receiver which stipulates how the sender is notified about the status of the sent message.

21. An apparatus for sending a message as claimed in claim 20, wherein the message is a multimedia message for a standardized multimedia messaging service.

22. An apparatus for sending a message as claimed in claim 20, wherein the receiver device extracts information about at least one of arrival of the message in a mailbox for the receiver from the first notification, arrival of a receiver notification about availability of the message for the receiver from a second notification from one of the receiver connection unit and the sender connection unit, and the receiver having downloaded the message from the receiver connection unit from a third notification from one of the receiver connection unit and the sender connection unit.

23. An apparatus for sending a message as claimed in claim 20, wherein a notification mode is coded in a data element in a header part of the send request, via which the sender receives at least one of the first notification, the second notification and the third notification.

24. An apparatus for sending a message as claimed in claim 20, wherein the information about arrival of the send request in the mailbox for the receiver is coded in a data element in a header part of the first notification.

25. An apparatus for sending a message as claimed in claim 20, wherein a status data element in a header part of the first notification has a value “Inbox-reached” when the message has reached the mailbox for the receiver.

26. An apparatus for sending a message as claimed in claim 22, wherein a delivery report data element in a header part of the send request is coded with at least one of “Inbox-reached” when the sender requests the first notification, “Notified” when the sender requests the second notification, and “Inbox-and-retrieved” when the sender requests the third notification, for purposes of at least one of controlling the receiver connection unit and notifying the receiver about a notification mode in force for the sender.

27. An apparatus for sending a message as claimed in claim 26, wherein a notification report data element in a header part of the send request is coded with a field name of the notification report data element as 0×89, and a field value of the notification report data element with YES when, in accordance with the send request, the sender requests a notification after a receiver notification has arrived with the receiver, otherwise with NO.

28. An apparatus for sending a message as claimed in claim 27, wherein an inbox reached report data element in the header part of the send request is coded with a field name of the inbox reached report data element as 0×90 and a field value of the inbox reached report data element with YES when the sender needs to receive the first notification about arrival of the message in a mailbox for the receiver, otherwise with NO.

29. An apparatus for sending a message as claimed in claim 28, wherein the notification report data element and the inbox reached report data element are combined to form one data element for subsequent coding.

30. An apparatus for sending a message as claimed in claim 20, wherein recognizability of a notification mode of the sender with the receiver is restricted.

31. An apparatus for receiving a message, comprising a receiver connection unit for receiving a message in a send request from a sender connection unit associated with a sender, wherein the receiver connection unit includes a notification generator for producing a first notification used to notify the sender of the message in accordance with a prescribed notification mode based on the send request being present in the receiver connection unit.

32. An apparatus for receiving a message as claimed in claim 31, wherein the message is deposited and made available for the receiver in a mailbox for the receiver in the receiver connection unit.

33. An apparatus for receiving a message as claimed in claim 31, wherein the first notification is transmitted by the receiver connection unit to a sender connection unit associated with the sender and on to the sender.

34. An apparatus for receiving a message as claimed in claim 31, wherein the message is a multimedia message for a standardized multimedia messaging service.

35. An apparatus for receiving a message as claimed in claim 31, wherein the notification mode includes at least one of a sending of the first notification, a sending of a second notification from the receiver connection unit to the sender connection unit if arrival of a receiver notification about the availability of the message is confirmed by the receiver and a sending of a third notification from the receiver connection unit to the sender connection unit if the receiver has downloaded the message from the receiver connection unit.

36. An apparatus for receiving a message as claimed in claim 31, wherein the notification mode is coded in a data element in a header part of the send request.

37. An apparatus for receiving a message as claimed in claim 32, wherein information about arrival of the send request in the mailbox for the receiver on the receiver connection unit is coded in a data element in a header part of the first notification.

38. An apparatus for receiving a message as claimed in claim 31, wherein the notification generator produces a receiver notification which informs the receiver about the notification mode in accordance with the send request.

39. An apparatus for receiving a message as claimed in claim 31, wherein the notification mode is coded in a data element in a header part of the receiver notification.

40. An apparatus for receiving a message as claimed in claim 31, wherein the notification mode is coded in a data element in a header part of a delivery message sent to the receiver by the receiver connection unit when the message is downloaded.

41. An apparatus for receiving a message as claimed in claim 35, wherein a status data element in a header part of at least one of the first notification, the second notification and the third notification is assigned a value “Inbox-reached” when the message has reached a mailbox for the receiver.

42. An apparatus for receiving a message as claimed in claim 35, wherein the receiver is notified about the notification mode in force for the sender by virtue of a delivery report data element in a header part of at least one of a receiver notification and a delivery message being coded with at least one of the “Inbox-reached” when the sender requests the first notification, “Notified” when the sender requests the second notification, and “Inbox-and-retrieved” when the sender requests the third notification.

43. An apparatus for receiving a message as claimed in claim 42, wherein a notification report data element in a header part of the send request is coded with a field name of the notification report data element as 0×89, and a field value of the notification report data element with YES when, in accordance with the send request, the sender wants a notification after a receiver notification has arrived with the receiver, otherwise with NO.

44. An apparatus for receiving a message as claimed in claim 43, wherein an inbox reached report data element in the header part of the send request is coded with a field name of the inbox reached report data element as 0×90, and field values of the inbox reached report data element with YES when, in accordance with the send request, the sender needs to receive the first notification about the arrival of the message in a mailbox for the receiver, otherwise with NO.

45. An apparatus for receiving a message as claimed in claim 44, wherein the notification report data element and the inbox reached report data element are combined to form one data element for subsequent coding.

46. An apparatus for receiving a message as claimed in claim 31, wherein recognizability of a notification mode of the sender with the receiver is restricted.

47. An apparatus for receiving a message as claimed in claim 42, wherein a delivery report data element in a header part of a receiver notification which informs the receiver about availability of the message is coded.

48. An apparatus for receiving a message as claimed in claim 47, wherein the receiver prevents the first notification from being sent.

49. An apparatus for receiving a message as claimed in claim 48, wherein the prevention is coded as an option in a multi-media messaging service user profile.
